(19) United States
(12) Patent Application Publication
(10) Pub. No.: US 2026/0099004 A1
(43) Pub. Date: Apr. 9, 2026

(54) OPTICAL WAVEGUIDE ELEMENT

(71) Applicant: SUMITOMO ELECTRIC INDUSTRIES, LTD., Osaka (JP)

(72) Inventors: Akira FUJISAWA, Osaka-shi (JP); Keiji TANAKA, Osaka-shi (JP); Yoshiyuki SUGIMOTO, Osaka-shi (JP)

(73) Assignee: SUMITOMO ELECTRIC INDUSTRIES, LTD., Osaka (JP)

(21) Appl. No.: 19/351,376

(22) Filed: Oct. 7, 2025

(30) Foreign Application Priority Data
Oct. 9, 2024 (JP) 2024-177417

(51) Int. Cl. G02B 6/122; G02B 6/12

(52) U.S. Cl. CPC G02B 6/1228; G02B 6/12002; G02B 2006/12038; G02B 2006/12061; G02B 2006/12116; G02B 2006/12152

(57) ABSTRACT

An optical waveguide element according to one embodiment includes a polarization rotation portion including a first tapered portion and a first reverse-tapered portion. A polarization rotation portion and A second waveguide portion are arranged in order along a first direction. The first tapered portion has a length in a second direction that changes along the first direction, the second direction intersecting the first direction. The first reverse-tapered portion has a length in the second direction that changes along the first direction. In a plan view of the substrate, the optical waveguide element has a distance in the second direction between a first center line a second center line that changes along the first direction, the first center line extending along a center of the first tapered portion in the second direction, the second center line extending along a center of the first reverse-tapered portion in the second direction.

### CROSS REFERENCE TO RELATED APPLICATIONS

This application claims priority based on Japanese Patent Application No. 2024-177417 filed on October 9, 2024, and the entire contents of the Japanese patent application are incorporated herein by reference.

### TECHNICAL FIELD

The present disclosure relates to an optical waveguide element.

### BACKGROUND

PCT International Publication No. WO 2014/207949 describes a polarization conversion element. The polarization conversion element is composed of an optical waveguide formed on a substrate. The optical waveguide includes a lower cladding formed on the substrate; a core formed on the lower cladding; and an upper cladding formed on the lower cladding and the core. The optical waveguide structure of the polarization conversion element includes a first waveguide portion, a polarization rotation portion, and a second waveguide portion. The core of the polarization rotation portion includes a thick plate portion and a thin plate portion having a thinner thickness than the thick plate portion. The thin plate portion exists below the thick plate portion. The cross-section of the core of the polarization rotation portion is asymmetric in a height direction. A mode conversion portion having a tapered shape is formed in a portion of the second waveguide portion on the side opposite to the polarization rotation portion. Accordingly, the polarization conversion element performs polarization rotation and mode conversion simultaneously.

United States Patent Application, Publication No. 2017/0269302 describes a mode converter that converts the mode of light between a silicon waveguide and a second waveguide. The mode converter includes an adiabatic taper of the silicon waveguide and an adiabatic taper of the second waveguide. At least a part of the adiabatic taper of the silicon waveguide and at least a part of the adiabatic taper of the second waveguide are adjacent to each other and overlap each other on a substrate.

The article “Compact Polarization Rotator on Silicon for Polarization-Diversified Circuits”, published in Optics Letters Vol. 36, No. 4 (2011), describes a polarization rotator including a Si element and a Si₃N₄ element. In the polarization rotator, mode conversion from a TE mode to a TM mode is performed inside the Si element. The Si₃N₄ element is asymmetrically disposed around the Si element. Accordingly, the mode is rotated in the polarization rotator.

The article “Mode-Evolution-Based Polarization Rotation and Coupling Between Silicon and Hybrid Plasmonic Waveguides”, published in Scientific Reports 5; 18375 (2015), describes a structure including a Si waveguide and a metal cap. In this structure, the TE0 mode of light inside the Si waveguide is converted into the mode of a plasmonic waveguide made of Si and metal. The Si waveguide and the metal cap have an asymmetric cross-sectional shape. Accordingly, polarization conversion can be performed.

An optical waveguide element may include a plurality of different materials. In such a manner, it is required to perform mode conversion and polarization rotation with high efficiency in a plurality of optical waveguides made of different materials.

### SUMMARY

An optical waveguide element according to the present disclosure is connected between a first waveguide portion and a second waveguide portion each formed on a substrate. The optical waveguide element includes a polarization rotation portion including a first tapered portion that is formed in a first layer located above the substrate and that is connected to the first waveguide portion, and a first reverse-tapered portion that is formed in a second layer located above the substrate and that is connected to the second waveguide portion, the second layer being different from the first layer. The first tapered portion includes a material different from a material of the first reverse-tapered portion. In a plan view of the substrate, the first tapered portion has a part that is overlapping with a part of the first reverse-tapered portion, and the first waveguide portion, the polarization rotation portion, and the second waveguide portion are arranged in order along a first direction. The first tapered portion has a length in a second direction that changes along the first direction, the second direction intersecting the first direction. The first reverse-tapered portion has a length in the second direction that changes along the first direction. In a plan view of the substrate, the optical waveguide element has a distance in the second direction between a first center line a second center line that changes along the first direction, the first center line extending along a center of the first tapered portion in the second direction, the second center line extending along a center of the first reverse-tapered portion in the second direction.

### BRIEF DESCRIPTION OF THE DRAWINGS

FIG. 1 is a plan view showing an optical waveguide element according to an embodiment.

FIG. 2 is a cross-sectional view taken along line A-A of FIG. 1.

FIG. 3 is a plan view showing an optical waveguide element according to a first modification example.

FIG. 4 is a cross-sectional view taken along line B-B of FIG. 3.

FIG. 5 is a cross-sectional view taken along line C-C of FIG. 3.

FIG. 6 is a plan view showing an optical waveguide element according to a second modification example.

FIG. 7 is a plan view showing an optical waveguide element according to a third modification example.

### DETAILED DESCRIPTION

An object of the present disclosure is to provide an optical waveguide element capable of performing mode conversion and polarization rotation with high efficiency in a plurality of optical waveguides made of different materials.

According to the present disclosure, it is possible to perform mode conversion and polarization rotation with high efficiency in a plurality of optical waveguides made of different materials.

First, the contents of an embodiment of the present disclosure will be listed and described. (1) An optical waveguide element according to one embodiment is connected between a first waveguide portion and a second waveguide portion each formed on a substrate. The optical waveguide element includes a polarization rotation portion including a first tapered portion that is formed in a first layer located above the substrate and that is connected to the first waveguide portion, and a first reverse-tapered portion that is formed in a second layer located above the substrate and that is connected to the second waveguide portion, the second layer being different from the first layer. The first tapered portion includes a material different from a material of the first reverse-tapered portion. In a plan view of the substrate, the first tapered portion has a part that is overlapping with a part of the first reverse-tapered portion, and the first waveguide portion, the polarization rotation portion, and the second waveguide portion are arranged in order along a first direction. The first tapered portion has a length in a second direction that changes along the first direction, the second direction intersecting the first direction. The first reverse-tapered portion has a length in the second direction that changes along the first direction. In a plan view of the substrate, the optical waveguide element has a distance in the second direction between a first center line a second center line that changes along the first direction, the first center line extending along a center of the first tapered portion in the second direction, the second center line extending along a center of the first reverse-tapered portion in the second direction.

The optical waveguide element includes the polarization rotation portion. The polarization rotation portion includes the first tapered portion connected to the first waveguide portion and the first reverse-tapered portion connected to the second waveguide portion and made of a material different from that of the first tapered portion. The length of the first tapered portion in the second direction changes along the first direction, and the length of the first reverse-tapered portion in the second direction changes along the first direction. In a plan view of the substrate, a part of the first tapered portion and a part of the first reverse-tapered portion overlap each other. As a result, in the first tapered portion and the first reverse-tapered portion which are made of different materials, mode conversion can be performed with high efficiency. In a plan view of the substrate, the distance between the first center line extending along the center of the first tapered portion in the second direction and the second center line extending along the center of the first reverse-tapered portion in the second direction changes along the first direction. Since the polarization rotation portion has an asymmetric shape due to the first tapered portion and the first reverse-tapered portion, polarization rotation can be performed with high efficiency in the first tapered portion and the first reverse-tapered portion.

(2) In (1) above, the first tapered portion may be made of silicon nitride, and the first reverse-tapered portion may be made of silicon. The first tapered portion, the first reverse-tapered portion may each be surrounded by silicon dioxide.

(3) In (2) above, the optical waveguide element may further include a second reverse-tapered portion formed in the second layer that connects the first reverse-tapered portion and the second waveguide portion to each other. The second reverse-tapered portion may be made of silicon and surrounded by silicon dioxide. In this case, the second reverse-tapered portion is interposed between the first reverse-tapered portion and the second waveguide portion, and therefore, a sudden change in the width from the first reverse-tapered portion to the second waveguide portion can be suppressed. As a result, since the first reverse-tapered portion can be smoothly connected to the second waveguide portion, the refractive index of light passing through the first reverse-tapered portion made of silicon can be made constant.

(4) In (2) or (3) above, the optical waveguide element may further include a second tapered portion formed in the first layer that connects the first tapered portion and the first waveguide portion to each other. The second tapered portion may be made of silicon nitride and surrounded by silicon dioxide. In this case, the second tapered portion is interposed between the first tapered portion and the first waveguide portion, and therefore, a sudden change in the width from the first tapered portion to the first waveguide portion can be suppressed. As a result, the first tapered portion can be smoothly connected to the first waveguide portion.

(5) In any one of (1) to (4) above, in the polarization rotation portion, the first center line and the second center line may intersect each other in a plan view of the substrate.

Hereinafter, a specific example of an optical waveguide element according to an embodiment will be described with reference to the drawings. The present disclosure is not limited to this example, but is defined by the claims, and is intended to include all modifications within the concept and scope of the claims and equivalents thereof. In the description of the drawings, the same or corresponding elements are denoted by the same reference signs, and duplicate descriptions will be omitted as appropriate. The drawings may be partially depicted in a simplified or exaggerated manner for ease of understanding, and dimensional ratios and the like are not limited to those shown in the drawings.

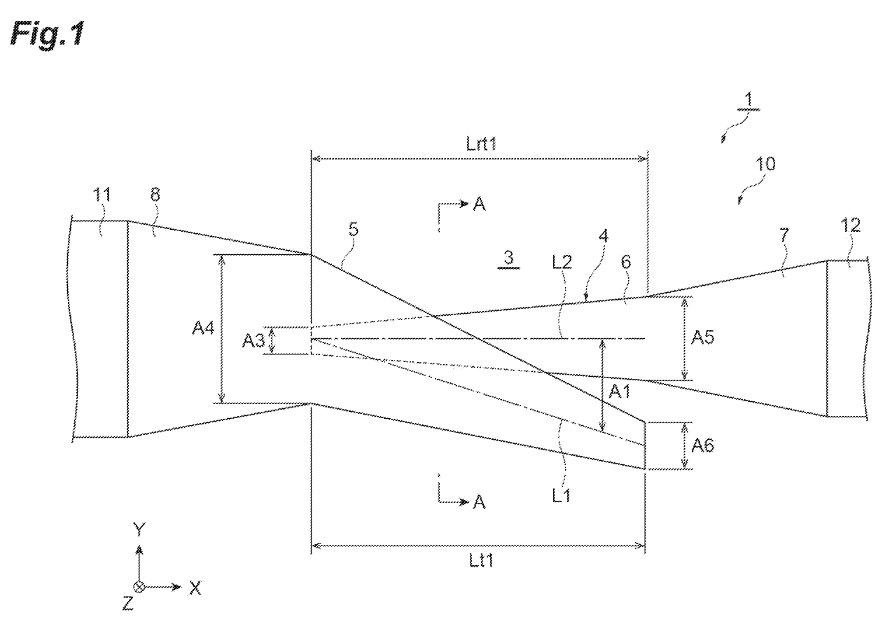

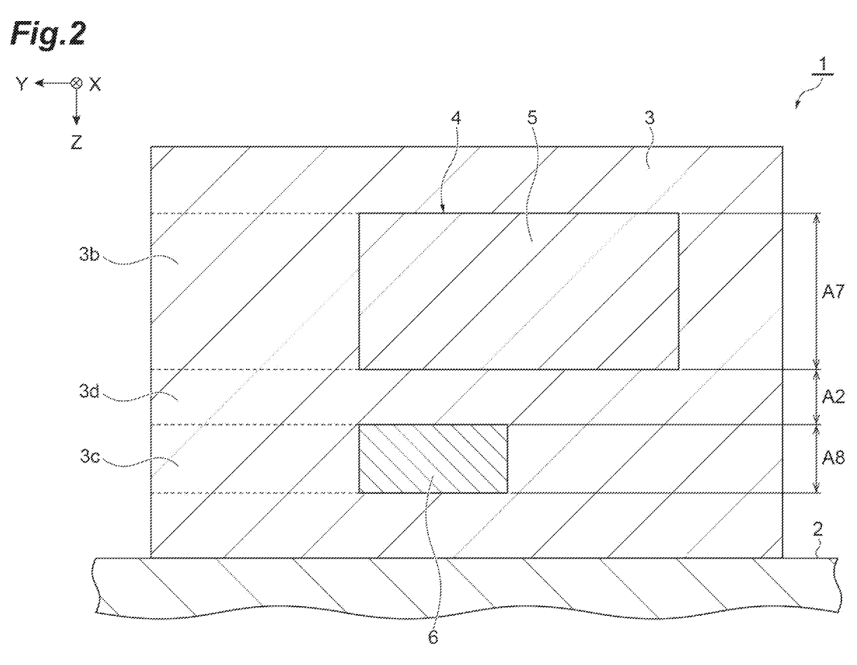

FIG. 1 is a view showing an optical waveguide element 1 according to the present embodiment. FIG. 2 is a cross-sectional view taken along line A-A of FIG. 1. As shown in FIGS. 1 and 2, the optical waveguide element 1 includes a substrate 2; a cladding 3 formed on the substrate 2; and an optical waveguide portion 4 embedded in the cladding 3. Hereinafter, the direction from the substrate 2 toward the cladding 3 may be referred to as top, upper side, or upward, and the direction from the cladding 3 toward the substrate 2 may be referred to as bottom, lower side, or downward. However, these directions are defined for the convenience of description, and do not limit the disposition positions or directions of the components.

Each individual portion covered with the cladding 3 is also referred to as a core. The substrate 2 is, for example, a semiconductor substrate. The semiconductor substrate is made of, for example, silicon (Si). For example, the cladding 3 has a thickness in a Z-axis direction (third direction) intersecting both an X-axis direction (first direction) and a Y-axis direction (second direction). Hereinafter, the X-axis direction, the Y-axis direction, and the Z-axis direction are also referred to as a length direction, a width direction, and a height direction, respectively. As one example, the cladding 3 has a rectangular parallelepiped shape extending in the X-axis direction, the Y-axis direction, and the Z-axis direction. The cladding 3 includes, for example, a first layer 3b and a second layer 3c located between the first layer 3b and the substrate 2. The cladding 3 further includes an intermediate layer 3d located between the first layer 3b and the second layer 3c. The first layer 3b and the second layer 3c are provided in the cladding 3. Each of the first layer 3b and the second layer 3c extends in the X-axis direction and the Y-axis direction, and has a thickness in the Z-axis direction. For example, the first layer 3b is provided on the upper side of the cladding 3, and the second layer 3c is provided below the first layer 3b. For example, the cladding 3 is made of, for example, silicon dioxide (SiO₂). The optical waveguide portion 4 is surrounded by the cladding 3.

The optical waveguide element 1 is connected between a first waveguide portion 11 and a second waveguide portion 12 formed on the substrate 2. The optical waveguide portion 4 functions as a core of the optical waveguide element 1. In a typical optical waveguide, due to a difference between the refractive index of a core and the refractive index of a cladding surrounding the core, light is confined within the core, and the light propagates in an extending direction of the core. The optical waveguide portion 4 includes a polarization rotation portion 10. In a plan view of the substrate 2 (when viewed along the Z-axis direction), the first waveguide portion 11, the polarization rotation portion 10, and the second waveguide portion 12 are arranged in order along the X-axis direction. The polarization rotation portion 10 includes a first tapered portion 5 connected to the first waveguide portion 11 and a first reverse-tapered portion 6 connected to the second waveguide portion 12. The optical waveguide portion 4 further includes a second reverse-tapered portion 7 connecting the first reverse-tapered portion 6 and the second waveguide portion 12 to each other, and a second tapered portion 8 connecting the first tapered portion 5 and the first waveguide portion 11 to each other. The first tapered portion 5, the first reverse-tapered portion 6, the second reverse-tapered portion 7, and the second tapered portion 8 are each surrounded by the cladding 3. The second reverse-tapered portion 7 is provided to gradually bring a length of the first reverse-tapered portion 6 in the Y-axis direction closer to a length of the second waveguide portion 12 in the Y-axis direction along the X-axis direction, and the second tapered portion 8 is provided to gradually bring a length of the first tapered portion 5 in the Y-axis direction closer to a length of the first waveguide portion 11 in the Y-axis direction along the X-axis direction. A length Lt1 of the first tapered portion 5 in the X-axis direction may be the same as a length Lrt1 of the first reverse-tapered portion 6 in the X-axis direction, or may be different from the length Lrt1 of the first reverse-tapered portion 6 in the X-axis direction. The length Lt1 is, for example, 10 μm or more and 3000 μm or less. The length Lt1 may be, for example, 100 μm or more and 2000 μm or less. The length Lt1 may be, for example, 300 μm or more and 1000 μm or less. The length Lrt1 is, for example, 10 μm or more and 3000 μm or less. The length Lrt1 may be, for example, 100 μm or more and 2000 μm or less. The length Lrt1 may be, for example, 300 μm or more and 1000 μm or less.

A material of the first tapered portion 5 is different from a material of the first reverse-tapered portion 6. For example, the first tapered portion 5 is made of silicon nitride (Si₃N₄), and the first reverse-tapered portion 6 is made of silicon (Si). The first waveguide portion 11, the second tapered portion 8, and the first tapered portion 5 are arranged in order along the X-axis direction. The first reverse-tapered portion 6, the second reverse-tapered portion 7, and the second waveguide portion 12 are arranged in order along the X-axis direction. For example, the first waveguide portion 11, the second tapered portion 8, and the first tapered portion 5 are integrally (as a continuous body) made of Si₃N₄, and the second waveguide portion 12, the second reverse-tapered portion 7, and the first reverse-tapered portion 6 are integrally (as a continuous body) made of Si. As will be described later, the first waveguide portion 11, the second tapered portion 8, and the first tapered portion 5 that are integrally formed and the second waveguide portion 12, the second reverse-tapered portion 7, and the first reverse-tapered portion 6 that are integrally formed are formed at different distances (heights) from an upper surface of the substrate 2 in the Z-axis direction. When the optical waveguide element 1 is manufactured on the substrate 2 using a semiconductor process, the optical waveguide element 1 is formed by stacking a plurality of layers. For example, the first waveguide portion 11, the second tapered portion 8, and the first tapered portion 5 are formed in the first layer 3b that is a single layer, and the second waveguide portion 12, the second reverse-tapered portion 7, and the first reverse-tapered portion 6 are formed in the second layer 3c that is a layer different from the first layer 3b. A distance between the first layer 3b and the substrate 2 is different from a distance between the second layer 3c and the substrate 2. FIG. 2 shows an example in which the first reverse-tapered portion 6 is formed in the second layer 3c and the first tapered portion 5 is formed in the first layer 3b above the second layer 3c. The intermediate layer 3d that is a single layer is provided between the first layer 3b and the second layer 3c. FIG. 2 shows a cross-section when viewed from the first waveguide portion 11 toward the second waveguide portion 12. Cross-sectional views to be described below also show cross-sections when viewed in the same orientation as in FIG. 2. The intermediate layer 3d may be omitted, and the first layer 3b may be formed directly on the second layer 3c.

In the optical waveguide element 1, light propagates through the polarization rotation portion 10 from the first waveguide portion 11 to the second waveguide portion 12. However, light also propagates through the polarization rotation portion 10 from the second waveguide portion 12 to the first waveguide portion 11. Therefore, the polarization rotation portion 10 can propagate light bidirectionally in the X-axis direction. For example, the first waveguide portion 11 transmits light in a transverse electric wave (TE) mode, and the second waveguide portion 12 transmits light in a transverse magnetic wave (TM) mode. The first waveguide portion 11 may transmit light in the TM mode, and the second waveguide portion 12 may transmit light in the TE mode. With the direction horizontal with respect to the upper surface of substrate 2 (the X-axis direction and the Y-axis direction) defined as a horizontal direction and with the direction perpendicular to the upper surface of substrate 2 (Z-axis direction) defined as a vertical direction, in the TE mode, the electric field of light oscillates in the horizontal direction, and in the TM mode, the electric field of light oscillates in the vertical direction. The polarization direction of light is the horizontal direction in the TE mode, and is the vertical direction in the TM mode. The polarization rotation portion 10 converts light in the TE mode into light in the TM mode, or converts light in the TM mode into light in the TE mode. This conversion is also referred to as polarization rotation since the conversion rotates the polarization direction of light by 90° between the horizontal direction and the vertical direction.

The second tapered portion 8 is located between the first waveguide portion 11 and the first tapered portion 5 in the X-axis direction. The shape of the second tapered portion 8 is a trapezoidal shape in a plan view of the substrate 2. A length of the second tapered portion 8 in the Y-axis direction decreases monotonically as the second tapered portion 8 extends from the first waveguide portion 11 toward the first tapered portion 5 along an X-axis (in the present application, such a trapezoidal shape is referred to as a taper or a forward taper). For example, the length of the second tapered portion 8 in the Y-axis direction may decrease uniformly (at a constant rate per unit length in the X-axis direction) along the X-axis direction. The first tapered portion 5 extends from the second tapered portion 8 in a direction opposite to the first waveguide portion 11, that is, toward the second waveguide portion 12. The shape of the first tapered portion 5 is a trapezoidal shape in a plan view of the substrate 2. The length of the first tapered portion 5 in the Y-axis direction changes along the X-axis direction. For example, the length of the first tapered portion 5 in the Y-axis direction decreases monotonically as the first tapered portion 5 extends away from the first waveguide portion 11 along the X-axis.

The second reverse-tapered portion 7 is located between the second waveguide portion 12 and the first reverse-tapered portion 6 in the X-axis direction. The shape of the second reverse-tapered portion 7 is a trapezoidal shape in a plan view of the substrate 2. A length of the second reverse-tapered portion 7 in the Y-axis direction decreases monotonically as the second reverse-tapered portion 7 extends from the second waveguide portion 12 toward the first reverse-tapered portion 6 along the X-axis (in the present application, such a trapezoidal shape is referred to as a reverse taper). For example, the length of the second reverse-tapered portion 7 in the Y-axis direction may decrease uniformly (at a constant rate per unit length in the X-axis direction) along the X-axis direction. The change in length in the Y-axis direction along the X-axis direction is in an opposite relationship between the taper (forward taper) and the reverse taper. The first reverse-tapered portion 6 extends from the second reverse-tapered portion 7 in a direction opposite to the second waveguide portion 12, that is, toward the first waveguide portion 11. The shape of the first reverse-tapered portion 6 is a trapezoidal shape in a plan view of the substrate 2. The length of the first reverse-tapered portion 6 in the Y-axis direction changes along the X-axis direction. For example, the length of the first reverse-tapered portion 6 in the Y-axis direction decreases monotonically as the first reverse-tapered portion 6 extends away from the second waveguide portion 12 along the X-axis.

In a plan view of the substrate 2, a part of the first tapered portion 5 and a part of the first reverse-tapered portion 6 overlap each other. That is, in a plan view of the substrate 2, a part of the first tapered portion 5 overlaps the first reverse-tapered portion 6. This overlap is enabled since the first tapered portion 5 and the first reverse-tapered portion 6 are formed at different distances from the substrate 2. In a plan view of the substrate 2, the first tapered portion 5 overlaps the first reverse-tapered portion 6 at a position close to the first waveguide portion 11 (second tapered portion 8), but does not overlap the first reverse-tapered portion 6 at a position close to the second waveguide portion 12 (second reverse-tapered portion 7). Accordingly, in the first tapered portion 5 and the first reverse-tapered portion 6, the mode conversion (mode transition) of light can be performed with high efficiency. In a plan view of the substrate 2, a distance A1 between a first center line L1 extending along the center of the first tapered portion 5 in the Y-axis direction and a second center line L2 extending along the center of the first reverse-tapered portion 6 in the Y-axis direction changes along the X-axis direction.

For example, the polarization rotation portion 10 includes a portion in which the distance A1 between the first center line L1 and the second center line L2 increases along the X-axis direction in a plan view of the substrate 2. In the present embodiment, this portion is included in a region in the X-axis direction from a boundary portion between the first tapered portion 5 and the second tapered portion 8 to a boundary portion between the first reverse-tapered portion 6 and the second reverse-tapered portion 7 in the polarization rotation portion 10. Since the distance A1 changes along the X-axis direction, the first center line L1 and the second center line intersect each other, and are neither coincident with each other nor parallel to each other. Therefore, the first tapered portion 5 has an asymmetric shape with respect to the second center line L2 of the first reverse-tapered portion 6. In the present application, being asymmetric means that the shape is not line-symmetric with respect to a certain axis of symmetry. In addition, the first reverse-tapered portion 6 has an asymmetric shape with respect to the first center line L1 of the first tapered portion 5.

In a plan view of the substrate 2, at least one of the shape of the first tapered portion 5 and the shape of the first reverse-tapered portion 6 is asymmetric with respect to a Y-axis. That is, at least one of the shape of the first tapered portion 5 and the shape of the first reverse-tapered portion 6 is asymmetric with respect to a center line passing through the center of the optical waveguide element 1 in the Y-axis direction and extending in the X-axis direction. In such a manner, the first center line L1 and the second center line L2 intersect each other, and a part of the first tapered portion 5 and a part of the first reverse-tapered portion 6 overlap each other, and therefore, the polarization direction of light rotates when the light propagates through the polarization rotation portion 10. FIG. 1 shows an example in which the center line is coincident with the second center line L2. With the center line as the axis of symmetry, the first tapered portion 5 is asymmetric, and the first reverse-tapered portion 6 is symmetric (line-symmetric). By the way, the first center line L1 may be coincident with the center line, and in this case, the first reverse-tapered portion 6 is asymmetric, and the first tapered portion 5 is symmetric (line-symmetric). Furthermore, both the first tapered portion 5 and the first reverse-tapered portion 6 may be asymmetric with respect to the center line.

For example, the first tapered portion 5 is disposed at a position above and spaced apart from the first reverse-tapered portion 6 in a cross-section orthogonal to the X-axis direction. However, the first tapered portion 5 may be disposed at a position below and spaced apart from the first reverse-tapered portion 6in a cross-section orthogonal to the X-axis direction. That is, the positional relationship between the first tapered portion 5 and the first reverse-tapered portion 6 in a cross-section orthogonal to the X-axis direction may be reversed. A spacing A2 between the first tapered portion 5 and the first reverse-tapered portion 6 in the Z-axis direction is, for example, greater than 0 nm and equal to or less than 400 nm. As described above, when the first tapered portion 5 is formed in the first layer 3b and the first reverse-tapered portion 6 is formed in the second layer 3c, the spacing A2 is equal to a spacing between the first layer 3b and the second layer 3c. A portion between the first layer 3b and the second layer 3c in the Z-axis direction is also formed as a single layer (intermediate layer 3d) by a semiconductor process. The intermediate layer 3d is made of, for example, SiO₂. The intermediate layer 3d may be omitted, and in this case, the spacing A2 may be zero.

The spacing A2 may be 1.0 μm or less. In this case, the mode transition in the polarization rotation portion 10 can be appropriately performed. Hereinafter, in a cross-section orthogonal to the X-axis direction, the direction in which the first reverse-tapered portion 6 and the first tapered portion 5 are viewed from the substrate 2 may be referred to as top or upward, and the direction in which the substrate 2 is viewed from the first tapered portion 5 and the first reverse-tapered portion 6 may be referred to as bottom or downward. However, these directions are defined for the convenience of describing relative positions and directions, and do not limit absolute disposition positions and directions that are independent of the orientation of the substrate 2.

A width A3 (length in the Y-axis direction) of a portion of the first reverse-tapered portion 6 farthest from the second reverse-tapered portion 7 in the X-axis direction (a portion closest to the first waveguide portion 11) is, for example, greater than 0 nm and equal to or less than 300 nm. The width A3 is set in accordance with a width A4 (length in the Y-axis direction) of the boundary portion between the first tapered portion 5 and the second tapered portion 8. The width A3 is smaller than the width A4. The width A4 is, for example, 400 nm or more and 1250 nm or less. A width A5 (length in the Y-axis direction) of the boundary portion between the first reverse-tapered portion 6 and the second reverse-tapered portion 7 is, for example, 200 nm or more and 600 nm or less. A width A6 (length in the Y-axis direction) of a portion of the first tapered portion 5 farthest from the second tapered portion 8 in the X-axis direction (a portion closest to the second waveguide portion 12) is, for example, greater than 0 nm and equal to or less than 400 nm. The width A6 is set to be smaller than the width A4 such that the first tapered portion 5 becomes a forward taper. In addition, the width A3 is set to be smaller than the width A5 such that the first reverse-tapered portion 6 becomes a reverse taper. The lower limit of the width A3 and the lower limit of the width A6 are minimum values to which manufacturing can be performed by a semiconductor process used in the manufacture of the optical waveguide element 1, and may be, for example, 0.05 μm. For example, the length of the first tapered portion 5 in the Y-axis direction may decrease uniformly (at a constant rate per unit length in the X-axis direction) from the width A4 to the width A6 along the X-axis direction from the boundary portion between the first tapered portion 5 and the second tapered portion 8 to the portion of the first tapered portion 5 farthest from the second tapered portion 8 (the portion closest to the second waveguide portion 12). For example, the length of the first reverse-tapered portion 6 in the Y-axis direction may increase uniformly (at a constant rate per unit length in the X-axis direction) from the width A3 to the width A5 along the X-axis direction from the portion of the first reverse-tapered portion 6 farthest from the second reverse-tapered portion 7 (the portion closest to the first waveguide portion 11) to the boundary portion between the first reverse-tapered portion 6 and the second reverse-tapered portion 7.

For example, the area of the cross-section of the first tapered portion 5 taken along a plane orthogonal to the X-axis direction, and the area of the cross-section of the first reverse-tapered portion 6 taken along a plane orthogonal to the X-axis direction change along the X-axis direction. The area of the cross-section of the first tapered portion 5 taken along a plane orthogonal to the X-axis direction decreases monotonically as the first tapered portion 5 extends from the first waveguide portion 11 toward the second waveguide portion 12. The area of the cross-section of the first reverse-tapered portion 6 taken along a plane orthogonal to the X-axis direction decreases monotonically as the first reverse-tapered portion 6 extends from the second waveguide portion 12 toward the first waveguide portion 11.

The shape of the first tapered portion 5 in a cross-section orthogonal to the X-axis direction is, for example, a rectangular shape. For example, when taken along a plane orthogonal to the X-axis direction, the length of the first tapered portion 5 in the Y-axis direction is greater than a length A7 of the first tapered portion 5 in the Z-axis direction. The length of the first tapered portion 5 in the Y-axis direction changes along the X-axis direction, whereas the length A7 of the first tapered portion 5 in the Z-axis direction is constant. The length A7 is equal to a thickness of the first layer 3b. The shape of the first reverse-tapered portion 6 in a cross-section orthogonal to the X-axis direction is, for example, a rectangular shape.

For example, when taken along a plane orthogonal to the X-axis direction, the length of the first reverse-tapered portion 6 in the Y-axis direction changes along the X-axis direction, whereas a length A8 of the first reverse-tapered portion 6 in the Z-axis direction is constant. The length A8 is equal to a thickness of the second layer 3c. For example, the length A7 is 300 nm or more and 1000 nm or less, and the length A8 is 100 nm or more and 400 nm or less. The shape of the first tapered portion 5 in a cross-section orthogonal to the X-axis direction and the shape of the first reverse-tapered portion 6 in a cross-section orthogonal to the X-axis direction may be a trapezoidal shape. In this case, for example, the trapezoidal shape may be formed such that a length of the upper side along the Y-axis farther from the substrate 2 is greater than a length of the lower side along the Y-axis closer to the substrate 2.

As described above, the optical waveguide element 1 includes the polarization rotation portion 10. The polarization rotation portion 10 includes the first tapered portion 5 connected to the first waveguide portion 11 and the first reverse-tapered portion 6 connected to the second waveguide portion 12 and made of a material different from that of the first tapered portion 5. The length of the first tapered portion 5 in the Y-axis direction changes along the X-axis direction, and the length of the first reverse-tapered portion 6 in the Y-axis direction changes along the X-axis direction. The first tapered portion 5 is formed in the first layer 3b in the Z-axis direction. The first reverse-tapered portion 6 is formed in the second layer 3c different from the first layer 3b in the Z-axis direction. In a plan view of the substrate 2, a part of the first tapered portion 5 and a part of the first reverse-tapered portion 6 overlap each other. As a result, in the first tapered portion 5 formed in the first layer 3b and the first reverse-tapered portion 6 formed in the second layer 3c which are made of different materials, the mode conversion of propagating light can be performed with high efficiency.

In a plan view of the substrate 2, a distance A1 between a first center line L1 extending along the center of the first tapered portion 5 in the Y-axis direction and a second center line L2 extending along the center of the first reverse-tapered portion 6 in the Y-axis direction changes along the X-axis direction. Since the polarization rotation portion 10 has an asymmetric shape due to the first tapered portion 5 and the first reverse-tapered portion 6, polarization rotation can be performed with high efficiency in the first tapered portion 5 and the first reverse-tapered portion 6. Furthermore, the polarization rotation portion 10 may include a portion in which the distance A1 between the first center line L1 and the second center line L2 increases monotonically along the X-axis direction in a plan view of the substrate 2.

As described above, the first tapered portion 5 formed in the first layer 3b may be made of Si₃N₄, and the first reverse-tapered portion 6 formed in the second layer 3c may be made of Si. In the first layer 3b and the second layer 3c, the portion other than the optical waveguides (cores) such as the first tapered portion 5 and the first reverse-tapered portion 6 is formed as the cladding 3, for example, from SiO₂. The optical waveguide element 1 may include the second reverse-tapered portion 7 connecting the first reverse-tapered portion 6 and the second waveguide portion 12 to each other. In this case, the second reverse-tapered portion 7 is interposed between the first reverse-tapered portion 6 and the second waveguide portion 12, and therefore, a sudden change in the width (length in the Y-axis direction) from the first reverse-tapered portion 6 to the second waveguide portion 12 can be suppressed. As a result, since the first reverse-tapered portion 6 can be gently connected to the second waveguide portion 12, for example, the refractive index of light passing through the first reverse-tapered portion 6 made of Si can be stabilized.

As described above, the optical waveguide element 1 may include the second tapered portion 8 connecting the first tapered portion 5 and the first waveguide portion 11 to each other. In this case, the second tapered portion 8 is interposed between the first tapered portion 5 and the first waveguide portion 11, and therefore, a sudden change in the width (length in the Y-axis direction) from the first tapered portion 5 to the first waveguide portion 11 can be suppressed. As a result, the first tapered portion 5 can be gently connected to the first waveguide portion 11.

Next, optical waveguide elements according to various modification examples will be described. Some configurations of the optical waveguide element according to each modification example to be described below are the same as some configurations of the optical waveguide element 1 described above. As a result, in the following description, portions that overlap with the portions of the optical waveguide element 1 described above are denoted by the same reference signs, and description thereof will be omitted as appropriate.

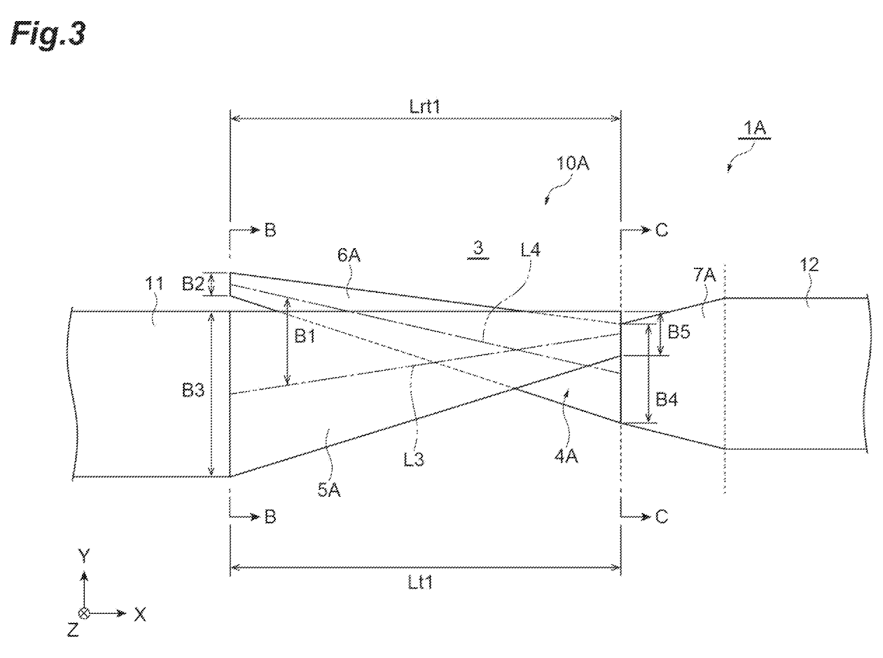

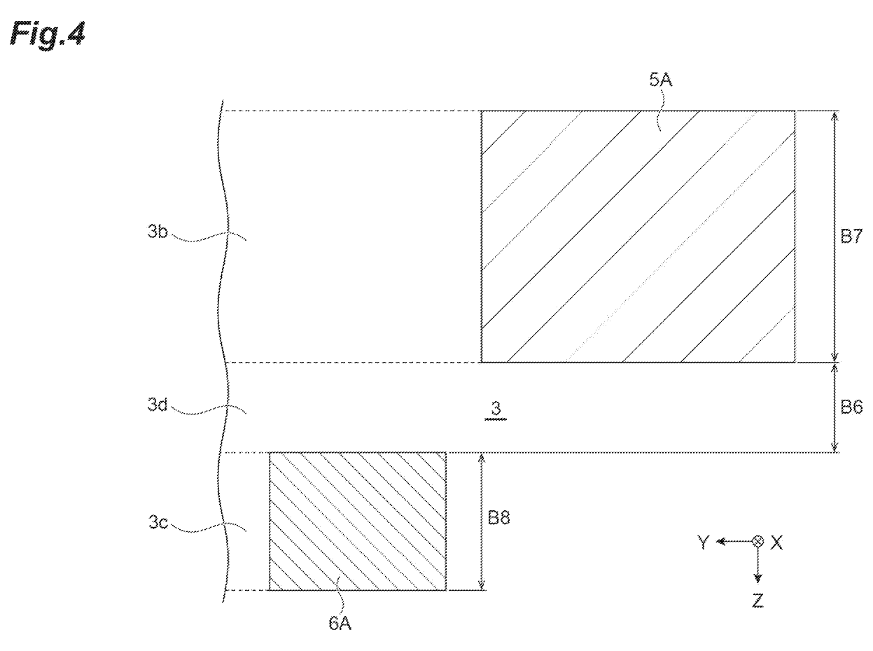

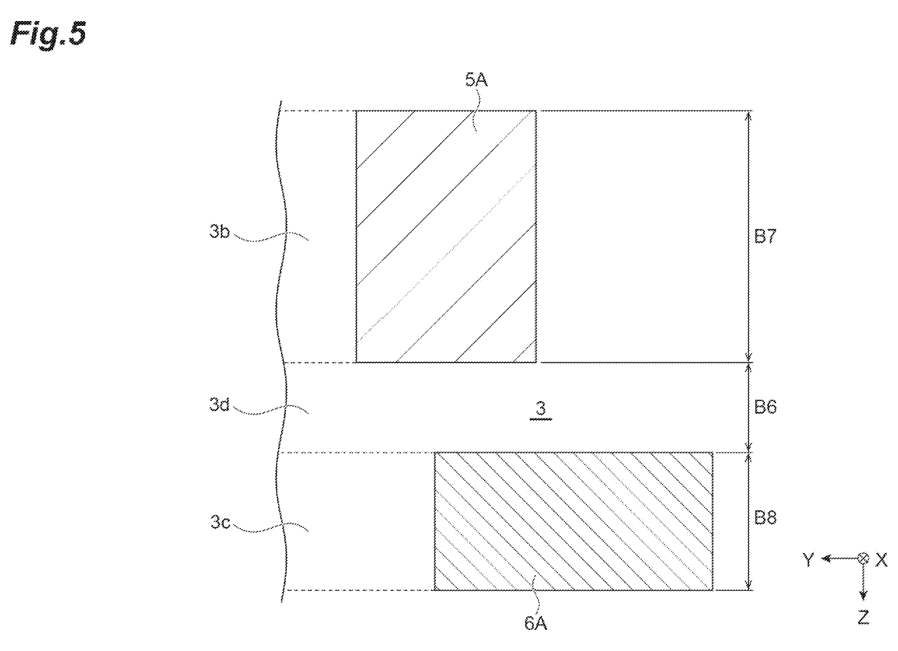

FIG. 3 is a view showing an optical waveguide element 1A according to a first modification example. FIG. 4 is a cross-sectional view taken along line B-B of FIG. 3. FIG. 5 is a cross-sectional view taken along line C-C of FIG. 3. As shown in FIGS. 3, 4, and 5, the optical waveguide element 1A includes an optical waveguide portion 4A that functions as a core embedded in the cladding 3. The optical waveguide portion 4A includes a polarization rotation portion 10A. The polarization rotation portion 10A includes a first tapered portion 5A connected to the first waveguide portion 11 and a first reverse-tapered portion 6A connected to the second waveguide portion 12. The optical waveguide portion 4A further includes a second reverse-tapered portion 7A connecting the first reverse-tapered portion 6A and the second waveguide portion 12 to each other. Unlike the optical waveguide portion 4 described above, the optical waveguide portion 4A does not include the second tapered portion 8. The first tapered portion 5A of the polarization rotation portion 10A is directly connected to the first waveguide portion 11.

The first tapered portion 5A and the first waveguide portion 11 are made of Si₃N₄, and the first reverse-tapered portion 6A, the second reverse-tapered portion 7A, and the second waveguide portion 12 are made of Si. For example, the first tapered portion 5A and the first waveguide portion 11 are formed in a layer (first layer 3b) located above the substrate 2. For example, the first reverse-tapered portion 6A, the second reverse-tapered portion 7A, and the second waveguide portion 12 are formed in a layer (second layer 3c) located above the substrate 2 and different from the first layer 3b. In the first layer 3b, the portion other than the first tapered portion 5A and the first waveguide portion 11 is made of SiO₂ as the cladding 3. In the second layer 3c, the portion other than the first reverse-tapered portion 6A, the second reverse-tapered portion 7A, and the second waveguide portion 12 is made of SiO₂ as the cladding 3. The first tapered portion 5A has a trapezoidal shape, and a length of the first tapered portion 5A in the Y-axis direction gradually decreases as the first tapered portion 5A extends away from the first waveguide portion 11. The first reverse-tapered portion 6A has a trapezoidal shape, and a length of the first reverse-tapered portion 6A in the Y-axis direction gradually decreases as the first reverse-tapered portion 6A extends away from the second waveguide portion 12. The second reverse-tapered portion 7A has a trapezoidal shape, and a length of the second reverse-tapered portion 7A in the Y-axis direction decreases as the second reverse-tapered portion 7A extends from the second waveguide portion 12 toward the first reverse-tapered portion 6A.

In a plan view of the substrate 2, a part of the first tapered portion 5A and a part of the first reverse-tapered portion 6A overlap each other. In a plan view of the substrate 2, a distance B1 between a first center line L3 extending along the center of the first tapered portion 5A in the Y-axis direction and a second center line L4 extending along the center of the first reverse-tapered portion 6A in the Y-axis direction changes along the X-axis direction. The polarization rotation portion 10A includes a portion in which the distance B1 between the first center line L3 and the second center line L4 increases along the X-axis direction in a plan view of the substrate 2. This portion is a region on the X-axis from an intersection portion of the first center line L3 and the second center line L4 to a portion of the first tapered portion 5A farthest from the first waveguide portion 11 in a plan view of the substrate 2. A region on the X-axis from a boundary portion between the first tapered portion 5A and the first waveguide portion 11 to the intersection portion of the first center line L3 and the second center line L4 in a plan view of the substrate 2 is a portion in which the distance B1 between the first center line L3 and the second center line L4 decreases along the X-axis direction.

A width B2 of a portion of the first reverse-tapered portion 6A farthest from the second waveguide portion 12 (a portion closest to the first waveguide portion 11) is, for example, greater than 0 nm and equal to or less than 300 nm (as one example, 100 nm). A width B3 of the boundary portion between the first waveguide portion 11 and the first tapered portion 5A is, for example, 400 nm or more and 1250 nm or less (as one example, 700 nm). A width B4 of a boundary portion between the first reverse-tapered portion 6A and the second reverse-tapered portion 7A is, for example, 200 nm or more and 600 nm or less (as one example, 300 nm). A width B5 of a portion of the first tapered portion 5A farthest from the first waveguide portion 11 (a portion closest to the second waveguide portion 12) is, for example, greater than 0 nm and equal to or less than 400 nm (as one example, 200 nm). The width B5 is set to be smaller than the width B3 such that the first tapered portion 5A becomes a forward taper. In addition, the width B2 is set to be smaller than the width B4 such that the first reverse-tapered portion 6A becomes a reverse taper. The lower limit of the width B2 and the lower limit of the width B5 are minimum values to which manufacturing can be performed by a semiconductor process used in the manufacture of the optical waveguide element 1A, and may be, for example, 0.05 μm.

In a cross-section orthogonal to the X-axis direction, the first tapered portion 5A is disposed at a position above and spaced apart from the first reverse-tapered portion 6A. For example, as described above, the first tapered portion 5A is formed in the first layer 3b, and the first reverse-tapered portion 6A is formed in the second layer 3c. A spacing B6 between the first tapered portion 5A and the first reverse-tapered portion 6A in the Z-axis direction is, for example, greater than 0 nm and equal to or less than 400 nm. The intermediate layer 3d is formed between the first layer 3b and the second layer 3c, and the spacing B6 is equal to the thickness of the intermediate layer 3d. The intermediate layer 3d is made of, for example, SiO₂. The intermediate layer 3d may be omitted, and in this case, the spacing B6 may be zero. A length B7 of the first tapered portion 5A in the Z-axis direction is greater than a length B8 of the first reverse-tapered portion 6A in the Z-axis direction. The length B7 is equal to the thickness of the first layer 3b, and the length B8 is equal to the thickness of the second layer 3c. Therefore, the thickness of the first layer 3b is greater than the thickness of the second layer 3c. For example, the length B7 is 300 nm or more and 1000 nm or less, and the length B8 is 100 nm or more and 400 nm or less.

As described above, in the optical waveguide element 1A, the polarization rotation portion 10A has an asymmetric shape due to the first tapered portion 5A and the first reverse-tapered portion 6A. As a result, the optical waveguide element 1A achieves the same effects as the optical waveguide element 1 described above. Furthermore, the optical waveguide element 1A does not include the second tapered portion 8 interposed between the first tapered portion 5A and the first waveguide portion 11. Therefore, in the optical waveguide element 1A in the X-axis direction, the element length in the X-axis direction can be reduced compared to the optical waveguide element 1 described above.

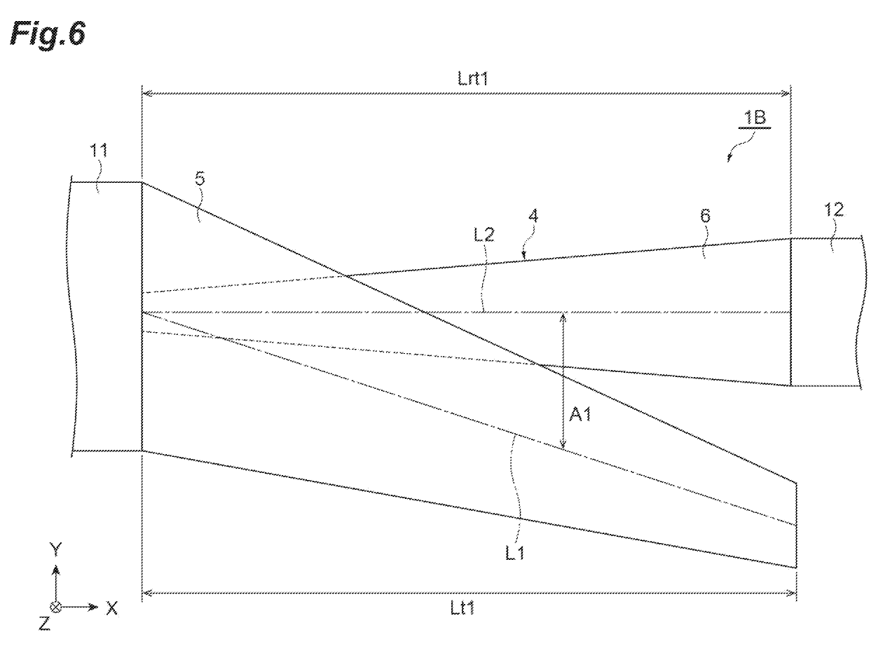

FIG. 6 is a view showing an optical waveguide element 1B according to a second modification example. The optical waveguide element 1B differs from the optical waveguide element 1 described above in that the optical waveguide element 1B does not include the second reverse-tapered portion 7 and the second tapered portion 8. In the optical waveguide element 1B, the first tapered portion 5 is directly connected to the first waveguide portion 11, and the first reverse-tapered portion 6 is directly connected to the second waveguide portion 12. In the optical waveguide element 1B, the element length in the X-axis direction can be further reduced compared to the optical waveguide element 1A described above. However, the optical waveguide element 1B has room for improvement in maintaining a constant refractive index of light.

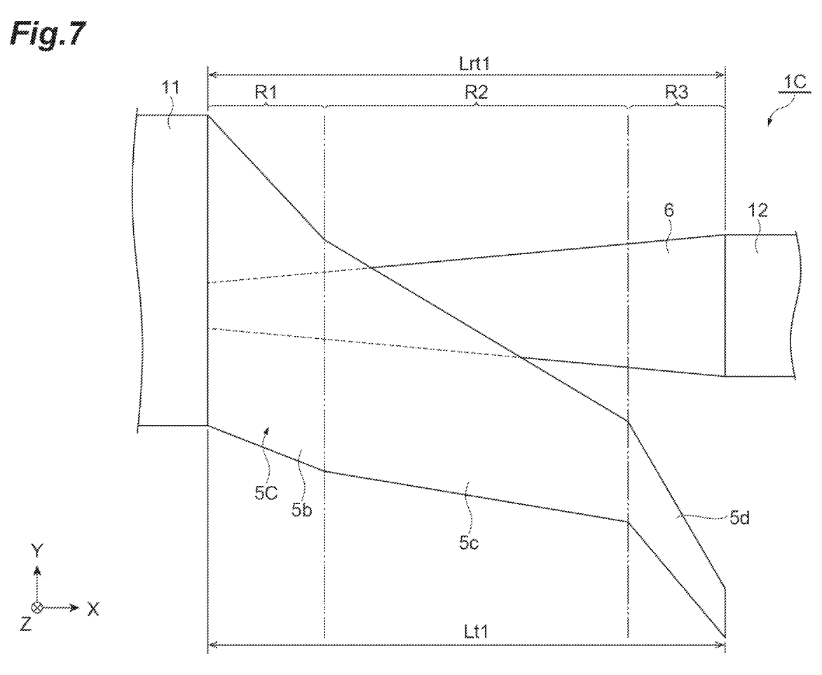

FIG. 7 is a view showing an optical waveguide element 1C according to a third modification example. The optical waveguide element 1C differs from the optical waveguide element 1B in that a first tapered portion 5C includes a first trapezoidal portion 5b, a second trapezoidal portion 5c, and a third trapezoidal portion 5d which have different shapes. In the first tapered portion 5C, the first trapezoidal portion 5b, the second trapezoidal portion 5c, and the third trapezoidal portion 5d are arranged in order along the X-axis direction. The optical waveguide element 1C has a first region R1, a second region R2, and a third region R3, and the first region R1, the second region R2, and the third region R3 are arranged in order along the X-axis direction.

In a plan view of the substrate 2, in the first region R1, the first trapezoidal portion 5b overlaps the first reverse-tapered portion 6. In a plan view of the substrate 2, in the second region R2, the second trapezoidal portion 5c overlaps a part of the first reverse-tapered portion 6, and the first reverse-tapered portion 6 includes a portion that the second trapezoidal portion 5c does not overlap. In a plan view of the substrate 2, in the third region R3, the third trapezoidal portion 5d does not overlap the first reverse-tapered portion 6. For example, a length of the second region R2 in the X-axis direction is greater than a length of the first region R1 in the X-axis direction, and the length of the first region R1 in the X-axis direction is greater than a length of the third region R3 in the X-axis direction.

As described above, in the optical waveguide element 1C, the first tapered portion 5C includes a plurality of the trapezoidal portions (for example, the first trapezoidal portion 5b, the second trapezoidal portion 5c, and the third trapezoidal portion 5d). Therefore, the shape of each trapezoidal portion of the first tapered portion 5C which overlaps the first reverse-tapered portion 6 in a plan view of the substrate 2 and the asymmetry of the first tapered portion 5C with respect to the Y-axis direction can be adjusted. In the optical waveguide element 1C, the first tapered portion 5C includes the plurality of trapezoidal portions and can be adjusted in various forms, and therefore, it is possible to maintain a constant refractive index of light while suppressing the element length of the optical waveguide element 1C in the X-axis direction.

The embodiment of the optical waveguide element according to the present disclosure has been described above. However, the present invention is not limited to the embodiment described above, and may be modified within the scope of the concept described in the claims. That is, the configuration, shape, size, material, number, and disposition mode of each portion of the optical waveguide element can be modified as appropriate within the scope of the concept.

What is claimed is:

1. An optical waveguide element connected between a first waveguide portion and a second waveguide portion each formed on a substrate, comprising:
a polarization rotation portion including a first tapered portion that is formed in a first layer located above the substrate and that is connected to the first waveguide portion, and
a first reverse-tapered portion that is formed in a second layer located above the substrate and that is connected to the second waveguide portion, the second layer being different from the first layer,
wherein the first tapered portion includes a material different from a material of the first reverse-tapered portion,
in a plan view of the substrate, the first tapered portion has a part that is overlapping with a part of the first reverse-tapered portion,
the first waveguide portion, the polarization rotation portion, and the second waveguide portion are arranged in order along a first direction,
the first tapered portion has a length in a second direction that changes along the first direction, the second direction intersecting the first direction,
the first reverse-tapered portion has a length in the second direction that changes along the first direction, and
in a plan view of the substrate, the optical waveguide element has a distance in the second direction between a first center line and a second center line that changes along the first direction, the first center line extending along a center of the first tapered portion in the second direction, the second center line extending along a center of the first reverse-tapered portion in the second direction.

2. The optical waveguide element according to claim 1, wherein the first tapered portion is made of silicon nitride, the first reverse-tapered portion is made of silicon, the first tapered portion, the first reverse-tapered portion are each surrounded by silicon dioxide.

3. The optical waveguide element according to claim 2, further comprising a second reverse-tapered portion formed in the second layer that connects the first reverse-tapered portion and the second waveguide portion to each other, the second reverse-tapered portion being made of silicon and surrounded by silicon dioxide.

4. The optical waveguide element according to claim 2, comprising a second tapered portion formed in the first layer that connects the first tapered portion and the first waveguide portion to each other, the second tapered portion being made of silicon nitride and surrounded by silicon dioxide.

5. The optical waveguide element according to claim 1, wherein, in the polarization rotation portion, the first center line and the second center line intersect each other in a plan view of the substrate.
